(19) United States
(12) Patent Application Publication
(10) Pub. No.: US 2007/0141470 A1
(43) Pub. Date: Jun. 21, 2007

(54) Lithium ion secondary battery

(76) Inventor: Kensuke Nakura, Osaka (JP)

Correspondence Address: MCDERMOTT WILL & EMERY LLP, 600 13TH STREET, N.W., WASHINGTON, DC, 20005-3096, US

(21) Appl. No.: 11/637,068

(22) Filed: Dec. 12, 2006

(30) Foreign Application Priority Data
Dec. 16, 2005 (JP) 2005-363760

(51) Int. Cl. H01M 4/52; H01M 4/50; H01M 10/40

(52) U.S. Cl. 429/231.3; 429/223; 429/231.6; 429/224; 429/231.5; 429/220; 429/330; 429/338

(57) ABSTRACT

A lithium ion secondary battery including a positive electrode containing an active material particle including a lithium composite oxide, wherein the lithium composite oxide is represented by LiₓM_{1-y}L_{y}O₂, where 0.85≦x≦1.25, 0≦y≦0.50, M is at least one element selected from the group consisting of Ni and Co, and L is at least one element selected from the group consisting of alkaline-earth elements, transition metal elements except Ni and Co, rare-earth elements, IIIb group elements and IVb group elements, and a molybdenum oxide represented by LiₐMoO_{b}, where 1≦a≦4 and 1≦b≦6, is present in a surface portion of the active material particle.

### FIELD OF THE INVENTION

The present invention relates to a lithium ion secondary battery having excellent life characteristics.

### BACKGROUND OF THE INVENTION

Lithium ion secondary batteries, the most typical example of non-aqueous electrolyte secondary batteries, have a high electromotive force and high energy density. Accordingly, the demand for lithium ion secondary batteries as main power sources for mobile communication devices and portable electronic devices is growing.

Enhancing reliability is an important technical issue in the development of lithium ion secondary batteries. Lithium composite oxides such as LiₓCoO₂ and LiₓNiO₂ (x varies by charge/discharge of a battery) contain high valent cobalt (Co⁴⁺) or nickel (Ni⁴⁺) which exhibits high reactivity during charge. Because of this, in a high temperature environment, electrolyte decomposition reaction involving lithium composite oxide is accelerated. As a result, gas is generated inside the battery, which may make it difficult to prevent heat generation in the event of a short circuit, or which may result in insufficient cycle characteristics or high temperature storage characteristics.

In view of the above, from the viewpoint of enhancing the reliability of lithium ion secondary batteries, proposals are made to prevent the electrolyte decomposition reaction involving lithium composite oxide by forming a specific metal oxide in a surface portion of positive electrode active material particles (see, e.g., Japanese Laid-Open Patent Publications Nos. Hei 9-35715, 11-317230 and 11-16566, and Japanese Laid-Open Patent Publications Nos. 2001-196063 and 2003-173775).

Also proposed is to improve cycle characteristics and high temperature storage characteristics by incorporating an additional element into a specific lithium composite oxide to form a solid solution so as to stabilize the crystal structure of the lithium composite oxide (see, e.g., Japanese Laid-Open Patent Publication No. Hei 11-40154 and Japanese Laid-Open Patent Publications Nos. 2004-111076 and 2002-15740).

Hitherto, a number of such proposals have been made to improve cycle characteristics and high temperature storage characteristics by preventing the generation of gas or by preventing the heat generation in the event of a short-circuit, but these techniques still need the following improvements to be made.

Most lithium ion secondary batteries are used in various portable devices. It is in practice not often the case that portable devices are always used immediately after the completion of charging. In other words, the batteries of portable devices are kept in a charged state for a long period of time, and then discharged. The cycle life characteristics of lithium ion secondary batteries, however, are generally evaluated under conditions different from the above actual operating conditions.

For example, a typical cycle life test is performed using a short rest time after charge (e.g., 30 minutes). In a cycle life test under this condition, the batteries proposed by the above related art techniques can exhibit somewhat improved cycle life characteristics.

However, taking the actual operating conditions into account, when these batteries are subjected to intermittent cycles (i.e. charge/discharge cycles using a longer rest time after charge of, for example, 720 minutes), any of these batteries cannot exhibit sufficient life characteristics.

In other words, in conventional lithium ion secondary batteries, the problem of improving intermittent cycle characteristics still remains.

### BRIEF SUMMARY OF THE INVENTION

In view of the above, an object of the present invention is to provide a lithium ion secondary battery having improved intermittent cycle characteristics including, as a positive electrode active material, a lithium composite oxide composed mainly of nickel or cobalt.

The present invention relates to a lithium ion secondary battery comprising: a positive electrode capable of charging and discharging; a negative electrode capable of charging and discharging; and a non-aqueous electrolyte. The positive electrode comprises an active material particle. The active material particle comprises a lithium composite oxide. The lithium composite oxide is represented by LiₓM_{1-y}L_{y}O₂, where 0.85≦x≦1.25, 0≦y≦0.5, M is at least one element selected from the group consisting of Ni and Co, and L is at least one element selected from the group consisting of alkaline-earth elements, transition metal elements except Ni and Co, rare-earth elements, IIIb group elements and IVb group elements. Further, a molybdenum oxide represented by LiₐMoO_{b}, where 1≦a≦4 and 1≦b≦6, is present in a surface portion of the active material particle.

When 0<y, L preferably is at least one selected from the group consisting of Al, Mn, Ti, Mg, Zr, Nb, Y, Ca, In and Sn.

The present invention encompasses the case where L is distributed more near the surface portion of the active material particle than inside the active material particle.

The amount of a molybdenum oxide represented by LiₐMoO_{b}, where 1≦a≦4 and 1≦b≦6, is preferably 2 mol % or less relative to the amount of the lithium composite oxide represented by LiₓM_{1-y}L_{y}O₂.

The active material particle preferably has an average particle size of 10 μm or greater.

To further improve the intermittent cycle characteristics, the non-aqueous electrolyte preferably includes at least one selected from the group consisting of vinylene carbonate, vinyl ethylene carbonate, fluorobenzene and phosphazene.

Usually, the molybdenum oxide (LiₐMoO_{b}) present in a surface portion of the active material particle has a crystal structure different from that of the lithium composite oxide represented by LiₓM_{1-y}L_{y}O₂ (hereinafter referred to as “lithium composite oxide ML”). The crystal structure of the lithium composite oxide ML is usually a layered structure (e.g., R3m) with a cubic close-packed oxygen array. LiₐMoO_{b}, on the other hand, has a composition such as Li₄MoO₅, Li₆Mo₂O₇, LiMoO₂, Li₂MoO₃ or Li₂MoO₄.

The lithium composite oxide ML represented by LiₓM_{1-y}L_{y}O₂ may contain Mo as L. The element L, however, is incorporated in the lithium composite oxide ML to form a solid solution. Accordingly, Mo contained in the lithium composite oxide ML as L can be distinguished from Mo contained in LiₐMoO_{b} by various analytical methods. Examples of the analytical method include element mapping by electron probe micro-analysis (EPMA), analysis of chemical bonding by X-ray photoelectron spectroscopy (XPS) and secondary ionization mass spectroscopy (SIMS).

By adding a molybdenum oxide represented by LiₐMoO_{b}, where 1≦a≦4 and 1≦b≦6, to a surface portion of an active material particle including a lithium composite oxide ML represented by LiₓM_{1-y}L_{y}O₂, where 0.85≦x≦1.25, 0≦y≦0.5, M is at least one element selected from the group consisting of Ni and Co, and L is at least one element selected from the group consisting of alkaline-earth elements, transition metal elements except Ni and Co, rare-earth elements, IIIb group elements and IVb group elements, intermittent cycle characteristics can be improved significantly.

When the lithium composite oxide ML includes at least one element L selected from the group consisting of Al, Mn, Ti, Mg, Zr, Nb, Y, Ca, In and Sn, intermittent cycle characteristics can be further improved.

Although the reason for the significant improvement of intermittent cycle characteristics is known only phenomenologically, at present, the following have been found from alternating current impedance analysis of the battery during intermittent cycles.

(1) When the molybdenum oxide represented by LiₐMoO_{b} is not present in a surface portion of the active material particle, the activation energy required for the intercalation and deintercalation of lithium ions into and from the active material particle <i> increases in proportion to the cycle number during intermittent cycles, and <ii> increases in proportion to the time length of rest interval between charge and discharge during intermittent cycles. Various experiments have revealed that the activation energy correlates with the solvation/desolvation of lithium ions.

(2) When the molybdenum oxide represented by LiₐMoO_{b} is present in a surface portion of the active material particle, the activation energy required for the intercalation and deintercalation of lithium ions into and from the active material particle <i> increases in proportion to the cycle number during intermittent cycles, but <ii> does not increase in proportion to the time length of rest interval between charge and discharge, and thus an increase in the activation energy is prevented.

From the foregoing, it can be assumed that the molybdenum oxide present in a surface portion of the active material particle has the effect of preventing an increase in the activation energy which correlates with the solvation/desolvation of lithium ions.

It has also been found that when the lithium composite oxide ML includes at least one element L selected from the group consisting of Al, Mn, Ti, Mg, Zr, Nb, Y, Ca, In and Sn, the increase of activation energy is further prevented.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a vertical cross sectional view of a cylindrical lithium ion secondary battery according to an embodiment of the present invention.

### DETAILED DESCRIPTION OF THE INVENTION

The following describes a positive electrode according to the present invention. The positive electrode comprises an active material particle as described below.

The active material particle comprises a lithium composite oxide ML. The lithium composite oxide ML is represented by LiₓM_{1-y}L_{y}O₂, where 0.85≦x≦1.25, 0≦y≦0.5, M is at least one element selected from the group consisting of Ni and Co, and L is at least one element selected from the group consisting of alkaline-earth elements, transition metal elements except Ni and Co, rare-earth elements, IIIb group elements and IVb group elements. In a surface portion of the active material particle, a molybdenum oxide represented by LiₐMoO_{b}, where 1≦a≦4 and 1≦b≦6, is present.

To further improve the intermittent cycle characteristics of the battery and to stabilize the crystal structure of the lithium composite oxide ML, L preferably is at least one selected from the group consisting of Al, Mn, Ti, Mg, Zr, Nb, Y, Ca, In and Sn, and more preferably at least one selected from the group consisting of Al, Mn, Ti, Mg, Zr, Nb, and Y. The element L contained in the lithium composite oxide ML may represent a single element or a plurality of elements.

The lithium composite oxide ML is usually composed of secondary particles each formed by the aggregation of a plurality of primary particles. The primary particles typically have, but are not limited to, an average particle size of 0.1 to 3 μm. The active material particle comprising a secondary particle of the lithium composite oxide has, but is not limited to, an average particle size of 1 to 30 μm, and more preferably 10 to 30 μm. The average particle size can be determined by a wet type laser particle size distribution analyzer manufactured by, for example, Microtrac Inc. In this case, a particle size at 50% accumulation in the particle size distribution based on volume (median value: D50) can be regarded as the average particle size of the active material particle.

In LiₓM_{1-y}L_{y}O₂, the value of x representing the amount of Li varies by charge/discharge of the battery. When the battery is discharged completely (i.e., in an initial state), x preferably satisfies 0.85≦x≦1.25, and more preferably 0.93≦x≦1.1.

The value of y representing the amount of L satisfies 0≦y≦0.5. Considering the balance of thermal stability and capacity of the lithium composite oxide ML, the value of y preferably satisfies 0.005≦y≦0.35, and more preferably 0.01≦y≦0.1. When 0.50<y, the advantage of using the active material composed mainly of Ni or Co vanishes, and higher capacity offered by the use of such active material cannot be achieved.

When M includes Co, the atomic ratio “a” of Co relative to the total of M and L is preferably 0.05≦a≦0.5, and more preferably 0.05≦a≦0.25.

When M includes Ni, the atomic ratio “b” of Ni relative to the total of M and L is preferably 0.25≦b≦0.9, and more preferably 0.30≦b≦0.85.

When L includes Al, the atomic ratio “c” of Al relative to the total of M and L is preferably 0.005≦c≦0.1, and more preferably 0.01≦c≦0.08.

When L includes Mn, the atomic ratio “d” of Mn relative to the total of M and L is preferably 0.005≦d≦0.5, and more preferably 0.01≦d≦0.35.

When L includes Ti, the atomic ratio “e” of Ti relative to the total of M and L is preferably 0.005≦e≦0.35, and more preferably 0.01≦e≦0.1.

The lithium composite oxide ML represented by LiₓM_{1-y}L_{y}O₂ can be synthesized by baking a starting material mixture having a specified metal element ratio in an oxidizing atmosphere. The starting material mixture contains lithium, at least one element M and optionally at least one element L. These metal elements are contained in the starting material mixture in the form of an oxide, hydroxide, oxyhydroxide, carbonate, nitrate, sulfate or organic complex salt. They may be used singly or in any combination of two or more.

To simplify the synthesis of the lithium composite oxide ML, the starting material mixture preferably includes a solid solution containing a plurality of metal elements. Examples of the solid solution containing a plurality of metal elements include a solid solution oxide, a solid solution hydroxide, a solid solution oxyhydroxide, a solid solution carbonate, a solid solution nitrate, a solid solution sulfate and a solid solution organic complex salt. For example, a solid solution containing Ni and Co, a solid solution containing Ni, Co and Al, a solid solution containing Ni, Co and Mn, and a solid solution containing Ni, Co and Ti can be used.

The baking temperature of the starting material mixture and the oxygen partial pressure of the oxidizing atmosphere depend on the composition and amount of the starting material mixture, and depend on the synthesis device used, but a person skilled in art can select appropriate conditions.

The starting material mixture may contain an element other than Li, M and L as an impurity in an amount normally contained in industrial materials, but even if it does, it does not impair the effect of the present invention.

Usually, the molybdenum oxide (LiₐMoO_{b}) contained in a surface portion of the active material particle is deposited on, attached to or carried by the surface of the lithium composite oxide ML.

The amount of the molybdenum oxide (LiₐMoO_{b}) contained in the active material particle is preferably 2 mol % or less relative to that of the lithium composite oxide ML, and more preferably not less than 0.1 mol % and not greater than 1.5 mol %. In other words, the amount of Mo contained in the molybdenum oxide (LiₐMoO_{b}) is preferably 2 mol % or less relative to the total of M and L contained in the lithium composite oxide ML (LiₓM_{1-y}L_{y}O₂), and more preferably not less than 0.1 mol % and not greater than 1.5 mol %. When the amount of molybdenum oxide (LiₐMoO_{b}) exceeds 2 mol %, the surface portion of the active material particle will serve as a resistance layer, increasing the overvoltage. As a result, the cycle characteristics start decreasing. Conversely, when the amount of molybdenum oxide (LiₐMoO_{b}) is less than 0.1 mol %, the effect of improving intermittent cycle characteristics may not be sufficient.

The Mo contained in the molybdenum oxide which is present in the surface portion may diffuse into the lithium composite oxide ML, and the concentration of L in the lithium composite oxide ML may become higher near the surface portion of the active material particle than inside the active material particle. In other words, Mo in the surface portion may transform into L of the lithium composite oxide ML. In this case, because the amount of Mo diffusing into the lithium composite oxide ML from the surface portion is very small, it can be ignored. It has little influence on the effect of the present invention.

When the active material comprises secondary particles each formed by the aggregation of primary particles, the molybdenum oxide may be present only on the surface of the primary particles, or only on the surface of the secondary particles, or on the surfaces of both the primary and secondary particles. In either case, the effect of the present invention is equally obtained.

A description is now given of a method for producing the positive electrode.

(i) First Step

A hydroxide serving as a starting material for the lithium composite oxide ML is first prepared. The method for preparing the hydroxide is not specifically limited. For example, an aqueous solution of a salt mixture containing at least one element M and at least one element L at a specified molar ratio is prepared. Alkali is then added to the aqueous solution to obtain a coprecipitated hydroxide.

To the obtained coprecipitated hydroxide, a specified amount of lithium compound is added to prepare a starting material mixture (first mixture) of coprecipitated hydroxide and lithium compound. The first mixture is then baked in an oxidizing atmosphere for about 10 hours, for example. Preferably, the first mixture is baked at 650 to 750° C. with a pressure of oxidizing atmosphere of 10 kPa to 50 kPa to synthesize a lithium composite oxide ML. The baking temperature and the oxygen partial pressure in the oxidizing atmosphere are appropriately selected according to the composition and amount of the first mixture, and the synthesis device used.

(ii) Second Step

To the obtained lithium composite oxide ML, a precursor material for molybdenum oxide (LiₐMoO_{b}) is added. For example, the lithium composite oxide ML is dispersed in an aqueous solution containing a molybdenum salt dissolved therein, which is then stirred and dried to obtain a composite of the lithium composite oxide ML and precursor material for molybdenum oxide (hereinafter referred to as “composite MLMo”).

Examples of the molybdenum salt include disodium molybdate dihydrate and hexaammonium heptamolybdate tetrahydrate. The temperature of the aqueous solution containing the molybdenum salt when introducing the lithium composite oxide ML and stirring the aqueous solution is not specifically limited. From the viewpoint of workability and production costs, the temperature is preferably controlled to 20 to 40° C. The stirring time is, but not limited to, three hours, for example. The method for removing the liquid component is not specifically limited. For example, the composite MLMo is dried, for example, at a temperature of about 100° C. for two hours.

(iii) Third Step

To the obtained composite MLMo, a lithium compound serving as another precursor material for LiₐMoO_{b} is added to obtain a second mixture. The second mixture is baked in an oxidizing atmosphere for 24 hours or longer, preferably 30 to 48 hours. Preferred temperature for baking the second mixture is 650 to 750° C. Preferred pressure of the oxidizing atmosphere is 10 kPa to 50 kPa. By baking the second mixture for such a long time, a phase comprising molybdenum oxide different from the lithium composite oxide ML deposits on the surface of the lithium composite oxide ML. The baking temperature and the oxygen partial pressure in the oxidizing atmosphere are appropriately selected according to the composition and amount of the second mixture, and the synthesis device used. The molybdenum oxide deposited on the surface of the lithium composite oxide ML has a composition represented by the general formula LiₐMoO_{b}, where 1≦a≦4 and 1≦b≦6.

(iv) Fourth Step

Using the active material particles obtained by the third step, a positive electrode is formed. The method for producing the positive electrode is not specifically limited. Usually, a positive electrode material mixture containing the active material particles and a binder is carried on a strip-shaped positive electrode core member (positive electrode current collector). Optionally, the positive electrode material mixture may further contain an additive such as a conductive material. The positive electrode material mixture is dispersed in a liquid component to prepare a paste. The paste is applied onto the core member, followed by drying. Thereby, the positive electrode material mixture can be carried on the core member. The positive electrode material mixture carried on the core member is rolled by rollers.

The binder contained in the positive electrode material mixture may be a thermoplastic resin or thermosetting resin. Preferred is a thermoplastic resin. Examples of the thermoplastic resin usable as the binder include polyethylene, polypropylene, polytetrafluoroethylene (PTFE), polyvinylidene fluoride (PVDF), styrene butadiene rubber, tetrafluoroethylene-hexafluoropropylene copolymer (FEP), tetrafluoroethylene-perfluoroalkylvinylether copolymer (PFA), vinylidene fluoride-hexafluoropropylene copolymer, vinylidene fluoride-chlorotrifluoroethylene copolymer, ethylene-tetrafluoroethylene copolymer (ETFE), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoromethylvinylether-tetrafluoroethylene copolymer, ethylene-acrylic acid copolymer, ethylene-methacrylic acid copolymer, ethylene-methyl acrylate copolymer and ethylene-methyl methacrylate copolymer. They may be used singly or in any combination of two or more. They may be crosslinked with Na ions.

The conductive material contained in the positive electrode material mixture can be any electron conductive material as long as it is chemically stable in the battery. Examples include: graphites such as natural graphite (e.g., flake graphite) and artificial graphite; carbon blacks such as acetylene black, ketjen black, channel black, furnace black, lamp black and thermal black; conductive fibers such as carbon fiber and metal fiber; metal powders such as aluminum powder; conductive whiskers such as zinc oxide and potassium titanate; conductive metal oxides such as titanium oxide; organic conductive materials such as a polyphenylene derivative; and carbon fluoride. They may be used singly or in any combination or two or more. The amount of the conductive material is preferably, but not limited to, 1 to 50 wt % relative to that of the active material particles contained in the positive electrode material mixture, more preferably 1 to 30 wt %, and particularly preferably 2 to 15 wt %.

The positive electrode core member (positive electrode current collector) may be any electron conductor as long as it is chemically stable in the battery. The positive electrode core member can be, for example, a foil or sheet made of aluminum, stainless steel, nickel, titanium, carbon or conductive resin. Preferred is an aluminum foil or aluminum alloy foil. A layer made of carbon or titanium may be applied onto the surface of the foil or sheet. Alternatively, an oxide layer may be formed. The surface of the foil or sheet may be roughened. It is also possible to use a net, punched sheet, lath, porous sheet, foam or a molded article formed by fiber bundle. The positive electrode core member has a thickness of, but is not specifically limited to, 1 to 500 μm.

The following describes the components of the lithium ion secondary battery of the present invention other than the positive electrode. It should be understood, however, the present invention is not limited to the description given below.

The negative electrode capable of charging and discharging comprises: for example, a negative electrode material mixture containing a negative electrode active material and a binder, and optionally a conductive material and a thickener; and a negative electrode core member carrying the negative electrode material mixture. Such negative electrode can be produced in the same manner as the positive electrode.

The negative electrode active material can comprise a metal comprising lithium or a material capable of electrochemically absorbing and desorbing lithium. Examples include graphite, a non-graphitizable carbon material, lithium alloy and metal oxide. The lithium alloy preferably comprises at least one selected from the group consisting of silicon, tin, aluminum, zinc and magnesium. The metal oxide is preferably an oxide containing silicon or an oxide containing tin. More preferably, the metal oxide is hybridized with a carbon material. The negative electrode active material preferably has, but is not limited to, 1 to 30 μm.

As the binder contained in the negative electrode material mixture, the same materials listed for the binder contained in the positive electrode material mixture can be used.

The conductive material contained in the negative electrode material mixture can be any electron conductive material as long as it is chemically stable in the battery. Examples include graphites such as natural graphite (e.g., flake graphite) and artificial graphite; carbon blacks such as acetylene black, ketjen black, channel black, furnace black, lamp black and thermal black; conductive fibers such as carbon fiber and metal fiber; metal powders such as copper powder and nickel powder; and organic conductive materials such as polyphenylene derivative. They may be used singly or in any combination of two or more. The amount of the conductive material is preferably, but not limited to, 1 to 30 wt % relative to that of the active material particles contained in the negative electrode material mixture, and more preferably 1 to 10 wt %.

The negative electrode core member (negative electrode current collector) may be any electron conductor as long as it is chemically stable in the battery. The negative electrode core member can be, for example, a foil or sheet made of stainless steel, nickel, copper, titanium, carbon or conductive resin. Preferred is a copper foil or copper alloy foil. A layer made of carbon, titanium or nickel may be applied onto the surface of the foil or sheet. Alternatively, an oxide layer may be formed. The surface of the foil or sheet may be roughened. It is also possible to use a net, punched sheet, lath, porous sheet, foam or a molded article formed by fiber bundle. The negative electrode core member has a thickness of, but is not specifically limited to, 1 to 500 μm.

The non-aqueous electrolyte preferably comprises a non-aqueous solvent containing a lithium salt dissolved therein.

Examples of the non-aqueous solvent include: cyclic carbonates such as ethylene carbonate (EC), propylene carbonate (PC) and butylene carbonate (BC); linear carbonates such as dimethyl carbonate (DMC), diethyl carbonate (DEC), ethyl methyl carbonate (EMC) and dipropyl carbonate (DPC); aliphatic carboxylic acid esters such as methyl formate, methyl acetate, methyl propionate and ethyl propionate; lactones such as γ-butyrolactone and γ-valerolactone; linear ethers such as 1,2-dimethoxyethane (DME), 1,2-diethoxyethane (DEE) and ethoxymethoxyethane (EME); cyclic ethers such as tetrahydrofuran and 2-methyltetrahydrofuran; dimethyl sulfoxide; 1,3-dioxolane; formamide; acetamide; dimethylformamide; dioxolane; acetonitrile; propylnitrile; nitromethane; ethyl monoglyme; phosphoric acid triester; trimethoxymethane; dioxolane derivative; sulfolane; methylsulfolane; 1,3-dimethyl-2-imidazolidinone; 3-methyl-2-oxazolidinone; propylene carbonate derivative; tetrahydrofuran derivative; ethyl ether; 1,3-propanesultone; anisole; dimethyl sulfoxide; and N-methyl-2-pyrrolidone. They may be used singly or in any combination of two or more. Particularly preferred is a solvent mixture composed of a cyclic carbonate and a liner carbonate or a solvent mixture composed of a cyclic carbonate, a liner carbonate and an aliphatic carboxylic acid ester.

Examples of the lithium salt dissolved in the non-aqueous solvent include LiClO₄, LiBF₄, LiPF₆, LiAlCl₄, LiSbF₆, LiSCN, LiCl, LiCF₃SO₃, LiCF₃CO₂, Li(CF₃SO₂)₂, LiAsF₆, LiN(CF₃SO₂)₂, LiB₁₀Cl₁₀, lithium lower aliphatic carboxylate, LiCl, LiBr, LiI, chloroboran lithium, lithium tetraphenylborate and lithium imide salt. They may be used singly or in any combination of two or more. It is preferred to use at least LiPF₆. The amount of the lithium salt dissolved in the non-aqueous solvent is preferably, but not limited to, 0.2 to 2 mol/L, and more preferably 0.5 to 1.5 mol/L.

In order to improve the charge/discharge characteristics of the battery, the non-aqueous electrolyte may further contain an additive. As the additive, it is preferred to use at least one selected from the group consisting of vinylene carbonate, vinyl ethylene carbonate, phosphazene and fluorobenzene. An appropriate amount of the additive is 0.5 to 10 wt %.

Additives other than the above can also be used such as triethyl phosphite, triethanolamine, a cyclic ether, ethylene diamine, n-glyme, pyridine, triamide hexaphosphate, nitrobenzene derivative, a crown ether, a quaternary ammonium salt and ethylene glycol dialkyl ether.

Between the positive and negative electrodes, a separator should be interposed.

The separator is preferably an insulating microporous thin film having high ion permeability and a certain mechanical strength. The microporous thin film preferably closes its pores at a certain temperature and has the function to raise the resistance. The microporous thin film is preferably made of polyolefin having excellent chemical resistance to solvents and hydrophobicity such as polypropylene or polyethylene. Alternatively, the separator may be a sheet, non-woven fabric or woven fabric made of glass fiber. The pore size is, for example, 0.01 to 1 μm. The thickness is typically 10 to 300 μm. The porosity is typically 30 to 80%.

A polymer electrolyte comprising the non-aqueous electrolyte and a polymer material for retaining the non-aqueous electrolyte may be combined together with the positive or negative electrode. The polymer material can be anything as long as it can retain the non-aqueous electrolyte. Particularly preferred is a copolymer of vinylidene fluoride and hexafluoropropylene.

### EXAMPLE 1

Battery A1

(i) Synthesis of Active Material Particle

A starting solution was prepared by dissolving 3.2 kg of a mixture of nickel sulfate and cobalt sulfate mixed at a molar ratio of Ni atoms and Co atoms of 80:20 in 10 L of water. To the starting solution was added 400 g of sodium hydroxide to form a precipitate. The obtained precipitate was washed with water, followed by drying, to obtain a coprecipitated hydroxide.

To the resulting Ni—Co coprecipitated hydroxide in an amount of 3 kg was added a certain amount of lithium carbonate, which was then baked at a temperature of 750° C. in an atmosphere with an oxygen partial pressure of 0.5 atm for 12 hours. Thereby, a lithium composite oxide ML (LiNi_{0.8}Co_{0.2}O₂) containing Ni and Co as M and containing no L was obtained.

A solution was prepared by dissolving disodium molybdate dihydrate in ion exchanged water. In this solution in an amount of 3 L was dispersed 3 kg of the above-obtained lithium composite oxide (LiNi_{0.8}Co_{0.2}O₂), which was stirred at 25° C. for three hours. Thereafter, the water was removed and the solid matter was dried at 100° C. for two hours. The amount of disodium molybdate dihydrate dissolved in the solution was 0.1 mol % relative to that of the lithium composite oxide ML.

To the thus-obtained lithium composite oxide ML (LiNi_{0.8}Co_{0.2}O₂) carrying Mo was added lithium carbonate such that the molar ratio Mo/Li was 2/1, which was then baked at a temperature of 750° C. in an atmosphere with an oxygen partial pressure of 0.2 atm for 24 hours. As a result, active material particles (average particle size: 12 μm) comprising: a lithium composite oxide ML (LiNi_{0.8}Co_{0.2}O₂) containing Ni and Co as M and containing no L; and a surface portion containing molybdenum oxide was obtained.

The surface portion of the obtained active material particles was analyzed by X-ray diffractometry (XRD), X-ray photoelectron spectroscopy (XPS), electron probe microanalysis (EPMA) and inductively coupled plasma (ICP) emission spectroscopy. As a result, it was found that the surface portion contained a molybdenum oxide represented by Li₄MoO₅.

(ii) Production of Positive Electrode

A positive electrode material mixture paste was prepared by mixing with stirring 1 kg of the obtained active material particles, 0.5 kg of PVDF#1320 (an N-methyl-2-pyrrolidone (NMP) solution containing 12 wt % PVDF) available from Kureha Chemical Industry Co., Ltd., 40 g of acetylene black and an appropriate amount of NMP with the use of a double arm kneader. This paste was applied onto both surfaces of a 20 μm thick aluminum foil, which was then dried and rolled such that the aluminum foil had a total thickness of 160 μm. The obtained electrode plate was then cut to have a width that allows it to be inserted into a battery case for 18650 type cylindrical batteries. Thereby, a positive electrode was obtained.

(iii) Production of Negative Electrode

A negative electrode material mixture paste was prepared by mixing with stirring 3 kg of artificial graphite, 200 g of BM-400B (a dispersion containing 40 wt % modified styrene-butadiene rubber) available from Zeon Corporation, Japan, 50 g of carboxymethyl cellulose (CMC) and an appropriate amount of water with the use of a double arm kneader. This paste was applied onto both surfaces of a 12 μm thick copper foil, which was then dried and rolled such that the copper foil had a total thickness of 160 μm. The obtained electrode plate was then cut to have a width that allows it to be inserted into a battery case for 18650 type cylindrical batteries. Thereby, a negative electrode was obtained.

(iv) Assembly of Battery

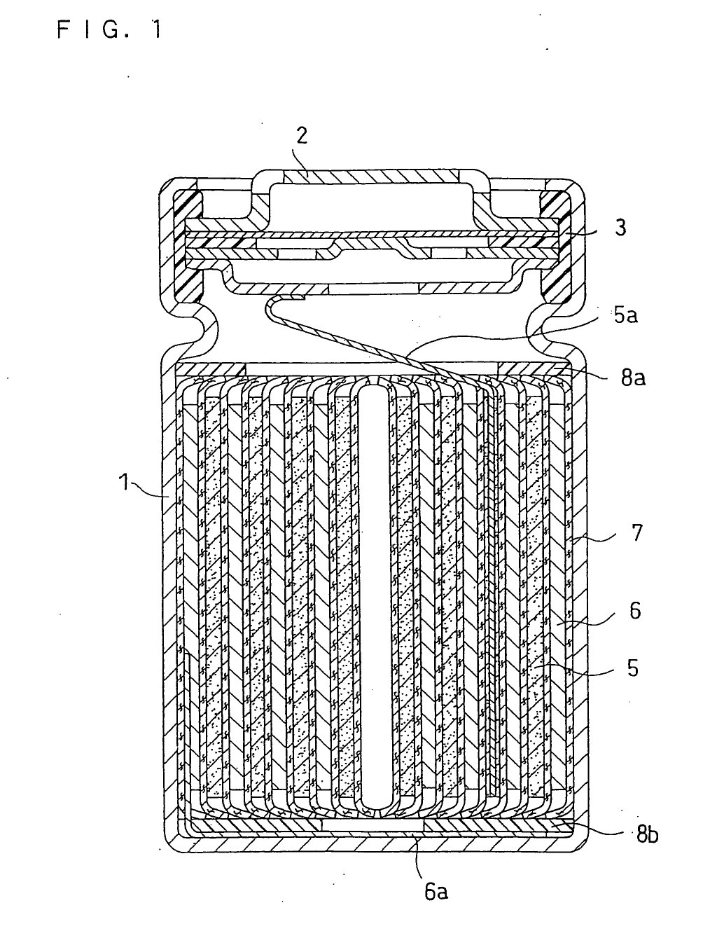

As shown in FIG. 1, a spirally wound electrode assembly was formed by spirally winding a positive electrode 5 and a negative electrode 6 with a separator 7 interposed therebetween. The separator 7 was a 25 μm thick composite film of polyethylene and polypropylene (Celgard 2300 available from Celgard Inc.).

A positive electrode lead 5a made of nickel was connected to the positive electrode 5, and a negative electrode lead 6a made of nickel was connected to the negative electrode 6. On the top of this electrode assembly was placed an upper insulating plate 8a, and a lower insulating plate 8b was placed on the bottom. The electrode assembly was then housed into a battery case 1, and 5g of non-aqueous electrolyte was injected into the battery case 1.

Ethylene carbonate and methyl ethyl carbonate were mixed at a volume ratio of 10:30 to obtain a solvent mixture. To the solvent mixture was added 2 wt % vinylene carbonate, 2 wt % vinyl ethylene carbonate, 5 wt % fluorobenzene and 5 wt % phosphazene to obtain a liquid mixture. The non-aqueous electrolyte was prepared by dissolving LiPF₆ in the liquid mixture at a LiPF₆ concentration of 1.5 mol/L.

Subsequently, a sealing plate 2 equipped with an insulating gasket 3 therearound was electrically connected to the positive electrode lead 5a. The opening of the battery case 1 was sealed with the sealing plate 2. Thereby, a 18650 type lithium secondary battery was obtained. This battery was denoted as Battery A1.

Battery A2

Battery A2 was produced in the same manner as Battery A1 was produced except that a mixture of nickel sulfate and cobalt sulfate mixed at a molar ratio of Ni atoms and Co atoms of 50:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A3

Battery A3 was produced in the same manner as Battery A1 was produced except that a mixture of nickel sulfate, cobalt sulfate and niobium nitrate mixed at a molar ratio of Ni atoms, Co atoms and Nb atoms of 80:15:5 was used for the synthesis of the coprecipitated hydroxide.

Battery A4

Battery A4 was produced in the same manner as Battery A1 was produced except that a mixture of nickel sulfate, cobalt sulfate and niobium nitrate mixed at a molar ratio of Ni atoms, Co atoms and Nb atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A5

Battery A5 was produced in the same manner as Battery A1 was produced except that a mixture of nickel sulfate, cobalt sulfate and manganese sulfate mixed at a molar ratio of Ni atoms, Co atoms and Mn atoms of 80:15:5 was used for the synthesis of the coprecipitated hydroxide.

Battery A6

Battery A6 was produced in the same manner as Battery A1 was produced except that a mixture of nickel sulfate, cobalt sulfate and manganese sulfate mixed at a molar ratio of Ni atoms, Co atoms and Mn atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A7

Battery A7 was produced in the same manner as Battery A1 was produced except that a mixture of nickel sulfate, cobalt sulfate and titanium sulfate (Ti(SO₄)₂) mixed at a molar ratio of Ni atoms, Co atoms and Ti atoms of 80:15:5 was used for the synthesis of the coprecipitated hydroxide.

Battery A8

Battery A6 was produced in the same manner as Battery A1 was produced except that a mixture of nickel sulfate, cobalt sulfate and titanium sulfate (Ti(SO₄)₂) mixed at a molar ratio of Ni atoms, Co atoms and Ti atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A9

Battery A9 was produced in the same manner as Battery A1 was produced except that a mixture of nickel sulfate, cobalt sulfate and magnesium sulfate mixed at a molar ratio of Ni atoms, Co atoms and Mg atoms of 80:15:5 was used for the synthesis of the coprecipitated hydroxide.

Battery A10

Battery A10 was produced in the same manner as Battery A1 was produced except that a mixture of nickel sulfate, cobalt sulfate and magnesium sulfate mixed at a molar ratio of Ni atoms, Co atoms and Mg atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A11

Battery A11 was produced in the same manner as Battery A1 was produced except that a mixture of nickel sulfate, cobalt sulfate and zirconium sulfate mixed at a molar ratio of Ni atoms, Co atoms and Zr atoms of 80:15:5 was used for the synthesis of the coprecipitated hydroxide.

Battery A12

Battery A12 was produced in the same manner as Battery A1 was produced except that a mixture of nickel sulfate, cobalt sulfate and zirconium sulfate mixed at a molar ratio of Ni atoms, Co atoms and Zr atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A13

Battery A13 was produced in the same manner as Battery A1 was produced except that a mixture of nickel sulfate, cobalt sulfate and aluminum sulfate mixed at a molar ratio of Ni atoms, Co atoms and A1 atoms of 80:15:5 was used for the synthesis of the coprecipitated hydroxide.

Battery A14

Battery A14 was produced in the same manner as Battery A1 was produced except that a mixture of nickel sulfate, cobalt sulfate and aluminum sulfate mixed at a molar ratio of Ni atoms, Co atoms and Al atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

Battery A15

Battery A15 was produced in the same manner as Battery A1 was produced except that a mixture of nickel sulfate, cobalt sulfate and yttrium nitrate hexahydrate mixed at a molar ratio of Ni atoms, Co atoms and Y atoms of 80:15:5 was used for the synthesis of the coprecipitated hydroxide.

Battery A16

Battery A16 was produced in the same manner as Battery A1 was produced except that a mixture of nickel sulfate, cobalt sulfate and yttrium nitrate hexahydrate mixed at a molar ratio of Ni atoms, Co atoms and Y atoms of 35:15:50 was used for the synthesis of the coprecipitated hydroxide, and that the amount of disodium molybdate dihydrate dissolved in ion exchanged water was changed to 2 mol % relative to that of the lithium composite oxide ML in the synthesis of the positive electrode active material.

### EXAMPLE 2

Batteries B1 to B16

Batteries B1 to B16 were produced in the same manner as Batteries A1 to A16 of EXAMPLE 1 were produced respectively except that, in the synthesis of the positive electrode active material, the amount of lithium carbonate added to the lithium composite oxide ML carrying Mo was changed such that the molar ratio Mo/Li was 8/3, and that subsequent baking was performed with an oxygen partial pressure of 0.06 atm and a baking temperature of 500° C.

The surface portions of the obtained active material particles were analyzed by XRD, XPS, EPMA and ICP emission spectroscopy. As a result, it was found that the surface portions contained a molybdenum oxide represented by Li₆Mo₂O₇ (i.e., Li₃MoO_{3.5}).

### EXAMPLE 3

Batteries C1 to C16

Batteries C1 to C16 were produced in the same manner as Batteries A1 to A16 of EXAMPLE 1 were produced respectively except that, in the synthesis of the positive electrode active material, the amount of lithium carbonate added to the lithium composite oxide ML carrying Mo was changed such that the molar ratio Mo/Li was 1/1, and that subsequent baking was performed with an oxygen partial pressure of 0.01 atm.

The surface portions of the obtained active material particles were analyzed by XRD, XPS, EPMA and ICP emission spectroscopy. As a result, it was found that the surface portions contained a molybdenum oxide represented by LiMoO₂.

### EXAMPLE 4

Batteries D1 to D16

Batteries D1 to D16 were produced in the same manner as Batteries A1 to A16 of EXAMPLE 1 were produced respectively except that, in the synthesis of the positive electrode active material, the amount of lithium carbonate added to the lithium composite oxide ML carrying Mo was changed such that the molar ratio Mo/Li was 4/1, and that subsequent baking was performed with an oxygen partial pressure of 0.06 atm.

The surface portions of the obtained active material particles were analyzed by XRD, XPS, EPMA and ICP emission spectroscopy. As a result, it was found that the surface portions contained a molybdenum oxide represented by Li₂MoO₃.

### EXAMPLE 5

Batteries E1 to E16

Batteries E1 to E16 were produced in the same manner as Batteries A1 to A16 of EXAMPLE 1 were produced respectively except that, in the synthesis of the positive electrode active material, the amount of lithium carbonate added to the lithium composite oxide ML carrying Mo was changed such that the molar ratio Mo/Li was 4/1, and that subsequent baking was performed with an oxygen partial pressure of 0.5 atm.

The surface portions of the obtained active material particles were analyzed by XRD, XPS, EPMA and ICP emission spectroscopy. As a result, it was found that the surface portions contained a molybdenum oxide represented by Li₂MoO₄.

### COMPARATIVE EXAMPLE 1

Comparative Batteries R1 to R16

Comparative Batteries R1 to R16 were produced in the same manner as Batteries A1 to A16 of EXAMPLE 1 were produced except that, in the synthesis of the positive electrode active material, the step of allowing the lithium composite oxide ML to carry Mo was omitted (in other words, the lithium composite oxide ML was not immersed in the aqueous solution of disodium molybdate dehydrate).

Evaluation

(Discharge Characteristics)

Each battery was subjected to pre-charge/discharge twice. The battery was then stored in an environment of 40° C. for two days. Thereafter, the battery was subjected to the following two different cycle tests. The design capacity of the batteries was 1 C mAh.

<First Pattern (Typical Cycle Test)>

(1) Constant current charge (45° C.): 0.7 C mA (end-of-charge voltage: 4.2 V)

(2) Constant voltage charge (45° C.): 4.2 V (end-of-charge current: 0.05 C mA)

(3) Rest time after charge (45° C.): 30 min.

(4) Constant current discharge (45° C.): 1 C mA (end-of-discharge voltage: 3 V)

(5) Rest time after discharge (45° C.): 30 min.

<Second Pattern (Intermittent Cycle Test)>

(1) Constant current charge (45° C.): 0.7 C mA (end-of-charge voltage: 4.2 V)

(2) Constant voltage charge (45° C.): 4.2 V (end-of-charge current: 0.05 C mA)

(3) Rest time after charge (45° C.): 720 min.

(4) Constant current discharge (45° C.): 1 C mA (end-of-discharge voltage: 3 V)

(5) Rest time after discharge (45° C.): 720 min.

The discharge capacities after 500 cycles obtained in the first and second patterns are shown in Tables 1 to 6.

TABLE 1

| | | | | Amount of | | |
|---|---|---|---|---|---|---|
| | | | | disodium | Intermittent cycle characteristics | |
| | | | | molybdate | Discharge capacity after 500 cycles | |
| | | | | dihydrate | Rest Time | |
| | | | | added | 30 min. at 45° C. | 720 min. at 45° C. |
| Battery No. | | Lithium composite oxide | LiₐMoO_{b} | (mol %) | (mAh) | (mAh) |
| Ex. 1 | A1 | LiNi_{0.80}Co_{0.20}O₂ | Li₄MoO₅ | 0.1 | 2200 | 2134 |
| Ex. 1 | A2 | LiNi_{0.50}Co_{0.50}O₂ | | 2.0 | 1690 | 1624 |
| Ex. 1 | A3 | LiNi_{0.80}Co_{0.15}Nb_{0.05}O₂ | | 0.1 | 2205 | 2139 |
| Ex. 1 | A4 | LiNi_{0.35}Co_{0.15}Nb_{0.50}O₂ | | 2.0 | 1694 | 1628 |
| Ex. 1 | A5 | LiNi_{0.80}Co_{0.15}Mn_{0.05}O₂ | | 0.1 | 2204 | 2160 |
| Ex. 1 | A6 | LiNi_{0.35}Co_{0.15}Mn_{0.50}O₂ | | 2.0 | 1695 | 1651 |
| Ex. 1 | A7 | LiNi_{0.80}Co_{0.15}Ti_{0.05}O₂ | | 0.1 | 2202 | 2158 |
| Ex. 1 | A8 | LiNi_{0.35}Co_{0.15}Ti_{0.50}O₂ | | 2.0 | 1692 | 1648 |
| Ex. 1 | A9 | LiNi_{0.80}Co_{0.15}Mg_{0.05}O₂ | | 0.1 | 2200 | 2156 |
| Ex. 1 | A10 | LiNi_{0.35}Co_{0.15}Mg_{0.50}O₂ | | 2.0 | 1697 | 1631 |
| Ex. 1 | A11 | LiNi_{0.80}Co_{0.15}Zr_{0.05}O₂ | | 0.1 | 2210 | 2144 |
| Ex. 1 | A12 | LiNi_{0.35}Co_{0.15}Zr_{0.50}O₂ | | 2.0 | 1697 | 1631 |
| Ex. 1 | A13 | LiNi_{0.80}Co_{0.15}Al_{0.05}O₂ | | 0.1 | 2207 | 2141 |
| Ex. 1 | A14 | LiNi_{0.35}Co_{0.15}Al_{0.50}O₂ | | 2.0 | 1697 | 1631 |
| Ex. 1 | A15 | LiNi_{0.80}Co_{0.15}Y_{0.05}O₂ | | 0.1 | 2203 | 2159 |
| Ex. 1 | A16 | LiNi_{0.35}Co_{0.15}Y_{0.50}O₂ | | 2.0 | 1697 | 1631 |

TABLE 2

| | | | | Amount of | | |
|---|---|---|---|---|---|---|
| | | | | disodium | Intermittent cycle characteristics | |
| | | | | molybdate | Discharge capacity after 500 cycles | |
| | | | | dihydrate | Rest Time | |
| | | | | added | 30 min. at 45° C. | 720 min. at 45° C. |
| Battery No. | | Lithium composite oxide | LiₐMoO_{b} | (mol %) | (mAh) | (mAh) |
| Ex. 2 | B1 | LiNi_{0.80}Co_{0.20}O₂ | Li₆Mo₂O₇ | 0.1 | 2202 | 2136 |
| Ex. 2 | B2 | LiNi_{0.50}Co_{0.50}O₂ | | 2.0 | 1699 | 1633 |
| Ex. 2 | B3 | LiNi_{0.80}Co_{0.15}Nb_{0.05}O₂ | | 0.1 | 2200 | 2134 |
| Ex. 2 | B4 | LiNi_{0.35}Co_{0.15}Nb_{0.50}O₂ | | 2.0 | 1697 | 1631 |
| Ex. 2 | B5 | LiNi_{0.80}Co_{0.15}Mn_{0.05}O₂ | | 0.1 | 2200 | 2134 |
| Ex. 2 | B6 | LiNi_{0.35}Co_{0.15}Mn_{0.50}O₂ | | 2.0 | 1695 | 1629 |
| Ex. 2 | B7 | LiNi_{0.80}Co_{0.15}Ti_{0.05}O₂ | | 0.1 | 2203 | 2159 |
| Ex. 2 | B8 | LiNi_{0.35}Co_{0.15}Ti_{0.50}O₂ | | 2.0 | 1695 | 1651 |
| Ex. 2 | B9 | LiNi_{0.80}Co_{0.15}Mg_{0.05}O₂ | | 0.1 | 2204 | 2160 |
| Ex. 2 | B10 | LiNi_{0.35}Co_{0.15}Mg_{0.50}O₂ | | 2.0 | 1692 | 1648 |
| Ex. 2 | B11 | LiNi_{0.80}Co_{0.15}Zr_{0.05}O₂ | | 0.1 | 2200 | 2156 |
| Ex. 2 | B12 | LiNi_{0.35}Co_{0.15}Zr_{0.50}O₂ | | 2.0 | 1692 | 1648 |
| Ex. 2 | B13 | LiNi_{0.80}Co_{0.15}Al_{0.05}O₂ | | 0.1 | 2200 | 2156 |
| Ex. 2 | B14 | LiNi_{0.35}Co_{0.15}Al_{0.50}O₂ | | 2.0 | 1695 | 1651 |
| Ex. 2 | B15 | LiNi_{0.80}Co_{0.15}Y_{0.05}O₂ | | 0.1 | 2203 | 2137 |
| Ex. 2 | B16 | LiNi_{0.35}Co_{0.15}Y_{0.50}O₂ | | 2.0 | 1695 | 1629 |

TABLE 3

| | | | | Amount of | | |
|---|---|---|---|---|---|---|
| | | | | disodium | Intermittent cycle characteristics | |
| | | | | molybdate | Discharge capacity after 500 cycles | |
| | | | | dihydrate | Rest Time | |
| | | | | added | 30 min. at 45° C. | 720 min. at 45° C. |
| Battery No. | | Lithium composite oxide | LiₐMoO_{b} | (mol %) | (mAh) | (mAh) |
| Ex. 3 | C1 | LiNi_{0.80}Co_{0.20}O₂ | LiMoO₂ | 0.1 | 2200 | 2134 |
| Ex. 3 | C2 | LiNi_{0.50}Co_{0.50}O₂ | | 2.0 | 1697 | 1631 |
| Ex. 3 | C3 | LiNi_{0.80}Co_{0.15}Nb_{0.05}O₂ | | 0.1 | 2207 | 2141 |
| Ex. 3 | C4 | LiNi_{0.35}Co_{0.15}Nb_{0.50}O₂ | | 2.0 | 1695 | 1629 |
| Ex. 3 | C5 | LiNi_{0.80}Co_{0.15}Mn_{0.05}O₂ | | 0.1 | 2200 | 2134 |
| Ex. 3 | C6 | LiNi_{0.35}Co_{0.15}Mn_{0.50}O₂ | | 2.0 | 1697 | 1631 |
| Ex. 3 | C7 | LiNi_{0.80}Co_{0.15}Ti_{0.05}O₂ | | 0.1 | 2201 | 2135 |
| Ex. 3 | C8 | LiNi_{0.35}Co_{0.15}Ti_{0.50}O₂ | | 2.0 | 1697 | 1631 |
| Ex. 3 | C9 | LiNi_{0.80}Co_{0.15}Mg_{0.05}O₂ | | 0.1 | 2204 | 2160 |
| Ex. 3 | C10 | LiNi_{0.35}Co_{0.15}Mg_{0.50}O₂ | | 2.0 | 1692 | 1648 |
| Ex. 3 | C11 | LiNi_{0.80}Co_{0.15}Zr_{0.05}O₂ | | 0.1 | 2205 | 2161 |
| Ex. 3 | C12 | LiNi_{0.35}Co_{0.15}Zr_{0.50}O₂ | | 2.0 | 1695 | 1651 |
| Ex. 3 | C13 | LiNi_{0.80}Co_{0.15}Al_{0.05}O₂ | | 0.1 | 2204 | 2160 |
| Ex. 3 | C14 | LiNi_{0.35}Co_{0.15}Al_{0.50}O₂ | | 2.0 | 1693 | 1649 |
| Ex. 3 | C15 | LiNi_{0.80}Co_{0.15}Y_{0.05}O₂ | | 0.1 | 2200 | 2156 |
| Ex. 3 | C16 | LiNi_{0.35}Co_{0.15}Y_{0.50}O₂ | | 2.0 | 1697 | 1653 |

TABLE 4

| | | | | Amount of | | |
|---|---|---|---|---|---|---|
| | | | | disodium | Intermittent cycle characteristics | |
| | | | | molybdate | Discharge capacity after 500 cycles | |
| | | | | dihydrate | Rest Time | |
| | | | | added | 30 min. at 45° C. | 720 min. at 45° C. |
| Battery No. | | Lithium composite oxide | LiₐMoO_{b} | (mol %) | (mAh) | (mAh) |
| Ex. 4 | D1 | LiNi_{0.80}Co_{0.20}O₂ | Li₂MoO₃ | 0.1 | 2203 | 2159 |
| Ex. 4 | D2 | LiNi_{0.50}Co_{0.50}O₂ | | 2.0 | 1697 | 1631 |
| Ex. 4 | D3 | LiNi_{0.80}Co_{0.15}Nb_{0.05}O₂ | | 0.1 | 2205 | 2139 |
| Ex. 4 | D4 | LiNi_{0.35}Co_{0.15}Nb_{0.50}O₂ | | 2.0 | 1697 | 1631 |
| Ex. 4 | D5 | LiNi_{0.80}Co_{0.15}Mn_{0.05}O₂ | | 0.1 | 2200 | 2134 |
| Ex. 4 | D6 | LiNi_{0.35}Co_{0.15}Mn_{0.50}O₂ | | 2.0 | 1692 | 1626 |
| Ex. 4 | D7 | LiNi_{0.80}Co_{0.15}Ti_{0.05}O₂ | | 0.1 | 2203 | 2137 |
| Ex. 4 | D8 | LiNi_{0.35}Co_{0.15}Ti_{0.50}O₂ | | 2.0 | 1695 | 1629 |
| Ex. 4 | D9 | LiNi_{0.80}Co_{0.15}Mg_{0.05}O₂ | | 0.1 | 2203 | 2137 |
| Ex. 4 | D10 | LiNi_{0.35}Co_{0.15}Mg_{0.50}O₂ | | 2.0 | 1697 | 1653 |
| Ex. 4 | D11 | LiNi_{0.80}Co_{0.15}Zr_{0.05}O₂ | | 0.1 | 2204 | 2160 |
| Ex. 4 | D12 | LiNi_{0.35}Co_{0.15}Zr_{0.50}O₂ | | 2.0 | 1694 | 1650 |
| Ex. 4 | D13 | LiNi_{0.80}Co_{0.15}Al_{0.05}O₂ | | 0.1 | 2200 | 2156 |
| Ex. 4 | D14 | LiNi_{0.35}Co_{0.15}Al_{0.50}O₂ | | 2.0 | 1695 | 1651 |
| Ex. 4 | D15 | LiNi_{0.80}Co_{0.15}Y_{0.05}O₂ | | 0.1 | 2201 | 2135 |
| Ex. 4 | D16 | LiNi_{0.35}Co_{0.15}Y_{0.50}O₂ | | 2.0 | 1697 | 1631 |

TABLE 5

| | | | | Amount of | | |
|---|---|---|---|---|---|---|
| | | | | disodium | Intermittent cycle characteristics | |
| | | | | molybdate | Discharge capacity after 500 cycles | |
| | | | | dihydrate | Rest Time | |
| | | | | added | 30 min. at 45° C. | 720 min. at 45° C. |
| Battery No. | | Lithium composite oxide | LiₐMoO_{b} | (mol %) | (mAh) | (mAh) |
| Ex. 5 | E1 | LiNi_{0.80}Co_{0.20}O₂ | Li₂MoO₄ | 0.1 | 2200 | 2134 |
| Ex. 5 | E2 | LiNi_{0.50}Co_{0.50}O₂ | | 2.0 | 1692 | 1626 |
| Ex. 5 | E3 | LiNi_{0.80}Co_{0.15}Nb_{0.05}O₂ | | 0.1 | 2200 | 2134 |
| Ex. 5 | E4 | LiNi_{0.35}Co_{0.15}Nb_{0.50}O₂ | | 2.0 | 1699 | 1633 |
| Ex. 5 | E5 | LiNi_{0.80}Co_{0.15}Mn_{0.05}O₂ | | 0.1 | 2202 | 2136 |
| Ex. 5 | E6 | LiNi_{0.35}Co_{0.15}Mn_{0.50}O₂ | | 2.0 | 1695 | 1629 |
| Ex. 5 | E7 | LiNi_{0.80}Co_{0.15}Ti_{0.05}O₂ | | 0.1 | 2201 | 2135 |
| Ex. 5 | E8 | LiNi_{0.35}Co_{0.15}Ti_{0.50}O₂ | | 2.0 | 1694 | 1628 |
| Ex. 5 | E9 | LiNi_{0.80}Co_{0.15}Mg_{0.05}O₂ | | 0.1 | 2200 | 2156 |
| Ex. 5 | E10 | LiNi_{0.35}Co_{0.15}Mg_{0.50}O₂ | | 2.0 | 1692 | 1648 |
| Ex. 5 | E11 | LiNi_{0.80}Co_{0.15}Zr_{0.05}O₂ | | 0.1 | 2204 | 2160 |
| Ex. 5 | E12 | LiNi_{0.35}Co_{0.15}Zr_{0.50}O₂ | | 2.0 | 1693 | 1649 |
| Ex. 5 | E13 | LiNi_{0.80}Co_{0.15}Al_{0.05}O₂ | | 0.1 | 2205 | 2161 |
| Ex. 5 | E14 | LiNi_{0.35}Co_{0.15}Al_{0.50}O₂ | | 2.0 | 1692 | 1648 |
| Ex. 5 | E15 | LiNi_{0.80}Co_{0.15}Y_{0.05}O₂ | | 0.1 | 2201 | 2157 |
| Ex. 5 | E16 | LiNi_{0.35}Co_{0.15}Y_{0.50}O₂ | | 2.0 | 1697 | 1653 |

TABLE 6

| | | | | Amount of | | |
|---|---|---|---|---|---|---|
| | | | | disodium | Intermittent cycle characteristics | |
| | | | | molybdate | Discharge capacity after 500 cycles | |
| | | | | dihydrate | Rest Time | |
| | | | | added | 30 min. at 45° C. | 720 min. at 45° C. |
| Battery No. | | Lithium composite oxide | LiₐMoO_{b} | (mol %) | (mAh) | (mAh) |
| Comp. | R1 | LiNi_{0.80}Co_{0.20}O₂ | No | — | 2200 | 1200 |
| Ex. 1 | | | | | | |
| Comp. | R2 | LiNi_{0.50}Co_{0.50}O₂ | | | 1694 | 502 |
| Ex. 1 | | | | | | |
| Comp. | R3 | LiNi_{0.80}Co_{0.15}Nb_{0.05}O₂ | | | 2202 | 1202 |
| Ex. 1 | | | | | | |
| Comp. | R4 | LiNi_{0.35}Co_{0.15}Nb_{0.50}O₂ | | | 1695 | 501 |
| Ex. 1 | | | | | | |
| Comp. | R5 | LiNi_{0.80}Co_{0.15}Mn_{0.05}O₂ | | | 2204 | 1201 |
| Ex. 1 | | | | | | |
| Comp. | R6 | LiNi_{0.35}Co_{0.15}Mn_{0.50}O₂ | | | 1698 | 500 |
| Ex. 1 | | | | | | |
| Comp. | R7 | LiNi_{0.80}Co_{0.15}Ti_{0.05}O₂ | | | 2202 | 1203 |
| Ex. 1 | | | | | | |
| Comp. | R8 | LiNi_{0.35}Co_{0.15}Ti_{0.50}O₂ | | | 1697 | 502 |
| Ex. 1 | | | | | | |
| Comp. | R9 | LiNi_{0.80}Co_{0.15}Mg_{0.05}O₂ | | | 2204 | 1204 |
| Ex. 1 | | | | | | |
| Comp. | R10 | LiNi_{0.35}Co_{0.15}Mg_{0.50}O₂ | | | 1697 | 502 |
| Ex. 1 | | | | | | |
| Comp. | R11 | LiNi_{0.80}Co_{0.15}Zr_{0.05}O₂ | | | 2205 | 1200 |
| Ex. 1 | | | | | | |
| Comp. | R12 | LiNi_{0.35}Co_{0.15}Zr_{0.50}O₂ | | | 1693 | 503 |
| Ex. 1 | | | | | | |
| Comp. | R13 | LiNi_{0.80}Co_{0.15}Al_{0.05}O₂ | | | 2203 | 1202 |
| Ex. 1 | | | | | | |
| Comp. | R14 | LiNi_{0.35}Co_{0.15}Al_{0.50}O₂ | | | 1692 | 504 |
| Ex. 1 | | | | | | |
| Comp. | R15 | LiNi_{0.80}Co_{0.15}Y_{0.05}O₂ | | | 2200 | 1200 |
| Ex. 1 | | | | | | |
| Comp. | R16 | LiNi_{0.35}Co_{0.15}Y_{0.50}O₂ | | | 1697 | 502 |
| Ex. 1 | | | | | | |

Lithium composite oxides ML synthesized using various starting materials other than the above coprecipitated hydroxides were also subjected to the same tests as above for evaluation, but the description thereof is omitted herein.

The present invention is usable in a lithium ion secondary battery whose positive electrode active material comprises a lithium composite oxide composed mainly of nickel or cobalt. According to the present invention, it is possible to further enhance cycle characteristics under conditions similar to the actual operating condition (e.g., intermittent cycle test) than conventional batteries.

The shape of the lithium ion secondary battery of the present invention is not specifically limited. It may have any shape such as a coin shape, button shape, sheet shape, cylinder, flat-shape or prism. The formation of the electrode assembly including positive and negative electrodes and a separator can be a spirally wound design or stack design. The size of the battery can be small enough for use in compact portable devices or large enough for use in electric vehicles. The lithium ion secondary battery of the present invention is applicable to, but not limited to, power sources for personal digital assistants, portable electronic devices, compact electrical energy storage systems for household use, two-wheeled vehicles, electric vehicles, hybrid electric vehicles, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A lithium ion secondary battery comprising:
a positive electrode capable of charging and discharging, said positive electrode comprising an active material particle, said active material particle comprising a lithium composite oxide;
a negative electrode capable of charging and discharging; and
a non-aqueous electrolyte,
wherein said lithium composite oxide is represented by LiₓM_{1-y}L_{y}O₂, where 0.85≦x≦1.25, 0≦y≦0.5, M is at least one element selected from the group consisting of Ni and Co, and L is at least one element selected from the group consisting of alkaline-earth elements, transition metal elements except Ni and Co, rare-earth elements, IIIb group elements and IVb group elements, and
a molybdenum oxide represented by LiₐMoO_{b}, where 1≦a≦4 and 1≦b≦6, is present in a surface portion of said active material particle.

2. The lithium ion secondary battery in accordance with claim 1,
wherein L is at least one selected from the group consisting of Al, Mn, Ti, Mg, Zr, Nb, Y, Ca, In and Sn.

3. The lithium ion secondary battery in accordance with claim 1,
wherein L is distributed more near said surface portion of said active material particle than inside said active material particle.

4. The lithium ion secondary battery in accordance with claim 1,
wherein the amount of said molybdenum oxide is 2 mol % or less relative to the amount of said lithium composite oxide.

5. The lithium ion secondary battery in accordance with claim 1,
wherein said active material particle has an average particle size of 10 μm or greater.

6. The lithium ion secondary battery in accordance with claim 1,
wherein said non-aqueous electrolyte includes at least one selected from the group consisting of vinylene carbonate, vinyl ethylene carbonate, fluorobenzene and phosphazene.
